(19) United States
(12) Patent Application Publication
(10) Pub. No.: US 2013/0218807 A1
(43) Pub. Date: Aug. 22, 2013

(54) System and Method for Valuation and Risk Estimation of Mortgage Backed Securities

(71) Applicant: Opera Solutions, LLC, (US)

(72) Inventors: Yuansong Liao, Bellevue, WA (US); Rui Yan, Hoboken, NJ (US); Ming Gu, Fullerton, CA (US); Xian Sun, Shanghai (CN); Xing Zhang, Shanghai (CN); Guhan Kandasamy, New York, NY (US); Laks Srinivasan, Bethlehem, PA (US); Bo Zhang, San Diego, CA (US)

(73) Assignee: OPERA SOLUTIONS, LLC, Jersey City, NJ (US)

(21) Appl. No.: 13/760,710

(22) Filed: Feb. 6, 2013

Related U.S. Application Data
(60) Provisional application No. 61/595,330, filed on Feb. 6, 2012.

(51) Int. Cl. G06Q 40/06

(52) U.S. Cl. CPC G06Q 40/06
USPC 705/36 R

(57) ABSTRACT

Systems and methods for investment production valuation and risk estimation for mortgage-backed security products are provided. In one embodiment, the disclosure provides a system for investment product valuation and risk estimation, comprising a computer system for receiving information about a mortgage-backed security, an engine executed by the computer system and processing the information about the mortgage-backed security to disaggregate individual loan data, the engine simulating future prices scenarios of the mortgage-backed security using one or more computer models to generate valuation and risk estimation data for the mortgage-backed security, and a user interface generated by the system for presenting a report to a user which includes the future price scenarios of the mortgage-backed security.

### CROSS-REFERENCE TO RELATED APPLICATIONS

This application claims the benefit of U.S. Provisional Application Ser. No. 61/595,330 filed on Feb. 6, 2012, the entire disclosure of which is expressly incorporated herein by reference.

### FIELD OF THE DISCLOSURE

The present disclosure relates to a system and method for investment product valuation and risk estimation for financial products, and more specifically, for mortgage-backed security (MBS) products.

### RELATED ART

The recent financial crisis triggered by the subprime mortgage crisis reveals flaws in security rating and pricing methods. For example, before the crisis MBS ratings were provided by rating agencies that did not reflect the actual risk of the loans in a pool because default risks of those loans were not continually monitored using up-to-date information. Mortgage-backed securities represent a significant portion of the outstanding U.S. fixed-income market. After the crisis, security valuation has increasingly focused on the underlying individual loans. Existing methods or systems rely on loan payment data, out-of-date borrower credit scores, and property valuation at the time of origination or securitization. However, these methods and systems lack data on critical drivers of loan performance, such as borrower credit dynamics after origination and current property valuation. Existing models often utilize parametric approaches, and are unable to handle the complex interactions among the variables that affect loan performance. Accordingly, what would be desirable, but has not yet been provided, is a system and method for valuation and risk estimation of mortgage-backed securities which addresses the foregoing needs.

### SUMMARY

The present disclosure relates to systems and methods for investment product valuation and risk estimation. In one embodiment, the disclosure provides a system for investment product valuation and risk estimation, comprising a computer system for receiving information about a mortgage-backed security, an engine executed by the computer system and processing the information about the mortgage-backed security to disaggregate individual loan data, the engine simulating future prices scenarios of the mortgage-backed security using one or more computer models to generate valuation and risk estimation data for the mortgage-backed security, and a user interface generated by the system for presenting a report to a user which includes the future price scenarios of the mortgage-backed security.

In another embodiment, the present disclosure relates to a method for investment product valuation and risk estimation. The method includes the steps of electronically receiving at a computer system information about a mortgage-backed security, executing an engine to process the information about a mortgage-backed security using one or more models for simulation of future scenarios of the mortgage-backed security to generate valuation and risk estimation data for the mortgage-backed security, and generating a user interface for presenting a report to a user which includes the future price scenarios of the mortgage-backed security.

In another embodiment, the present disclosure relates to a computer-readable medium having computer-readable instructions stored thereon which, when executed by a computer system, cause the computer system to perform the steps of electronically receiving at the computer system information about a mortgage-backed security, executing an engine to process the information about a mortgage-backed security using one or more models for simulation of future scenarios of the mortgage-backed security to generate valuation and risk estimation data for the mortgage-backed security, and generating a user interface for presenting a report to a user which includes the future price scenarios of the mortgage-backed security.

### BRIEF DESCRIPTION OF THE DRAWINGS

The foregoing features of the disclosure will be apparent from the following Detailed Description, taken in connection with the following drawings, in which:

FIG. 1 is a flowchart showing process steps according to the present disclosure for mortgage-backed security valuation and risk estimation;

FIG. 2 is a diagram illustrating computer models in accordance with the present disclosure;

FIGS. 3A-3B are examples of model performance of a transition matrix model;

FIG. 4 is a visual illustration of bond clustering performed by the system using a Mark-to-Market model;

FIGS. 5-6 illustrate operation of the Mark-to-Market model of the present disclosure;

FIG. 7 is a diagram showing the generation of market effect paths using the Monte Carlo simulation engine of the system;

FIGS. 8A-9 are graphs illustrating the operation of the Monte Carlo simulation engine of the system;

FIGS. 10A-11B are screenshots of user interface screens generated by the system of the present disclosure to output reports and information to a user; and

FIGS. 12-13 are diagrams showing hardware and software components of the system of the present disclosure.

### DETAILED DESCRIPTION

The present disclosure relates to a system and method for mortgage-backed security valuation. The present disclosure is a fully integrated valuation, surveillance, and risk management platform for mortgage-backed securities and whole loans. The system could provide analytics on thousands of bonds (e.g., 80,000), which could include every non-agency residential mortgage backed security (RMBS) bond on the market. The system allows users to quickly and easily access all of the data required to value mortgages and asset-backed securities through a computerized (e.g., desktop/web) interface. The system has a full array of analytics outputs, and permits a user to perform concise analysis to establish each asset's true worth. The system dramatically improves the quantity and quality of signals that investors, originators, and servicers have about their portfolios.

An MBS financial transaction could be supported by cash flow from thousands of sources. For instance, an RMBS deal can be supported by cash flow from thousands of mortgages. The cash flow from an RMBS deal supports the payment for multiple bonds of different payment schedules and seniority. For instance, a bond could have a credit rating, such as AAA (stable payment, low risk, low coupon, low yield) and B (less stable payment, high risk, high coupon, high yield).

To better predict the probability of default (e.g, constant default rate (CDR)), prepayment (e.g., conditional prepayment rate (CPR)), and loss severity (e.g., loss given default (LGD), principal loss upon loan default and liquidation, etc.) for each loan, the system disaggregates an MBS into underlying individual loans, incorporating an individual borrower's up-to-date credit information, zip code or sub-zip code level property valuation information, loan property, and time series of payment data, etc. The system utilizes loan-level default and prepayment scores combined with property and macroeconomic projections to further model each loan's sensitivity to different economic conditions. The system aggregates loan-level projections to ground group or pool level and generates multiple default, prepayment, and LGD projections at the individual loan level using sensitivity models and Monte Carlo simulation on economic conditions at different geographical levels and time horizons. By analyzing the full distribution of likely prices generated by a multi-path model, powered by a Monte Carlo simulation engine, the user can establish a baseline price for each asset under customized scenarios.

The system of the present disclosure uses a top-down approach in valuating an MBS bond (e.g., RMBS bond), and evaluates price, cash flow (CF), and CDR, preferably in that order. Price depends on monthly cash flows and discounting factors and is represented by:

$$\begin{matrix}Equation 1 & \\ PRICE = {\sum }_{i = 1}^{n} f ( {CF}_{i} , {Y}_{i} ) & \end{matrix}$$

Each month's cash flow depends on the pool-level monthly CDR, prepayment rate, and loss severity until the current month and is represented by:

CFₙ=g(CDR₁,CPR₁,Severity₁,CDR₂,CPR₂,Severity₂, . . . CDRₙ,CPRₙ,Severityₙ) Equation 2

Default rate is a loan's likelihood of default for a month which depends on a combination of its previous month's states, as well as macroeconomic factors in the current month, and is represented by:

CDRₙ=h(CDRₙ₋,CPRₙ₋₁,Unemployment_Rateₙ,HPIₙ,Interest_Rateₙ, . . . ) Equation 3

The system and interface could be scaled (e.g., near-, medium-, and long-term augmentation) into other asset classes, such as non-agency RMBS, agency RMBS, commercial mortgage-backed security (CMBS), muni bonds, whole loans, and other asset-backed securities (ABS) (e.g., Re-REMICs (Re-securitizations of Real Estate Mortgage Investment Conduits), credit cards, student loans, etc.). For example, near-term augmentation could rely on the foundation of existing models, interface and technological infrastructure, and medium-term augmentation could rely on vendor partnerships and joint ventures.

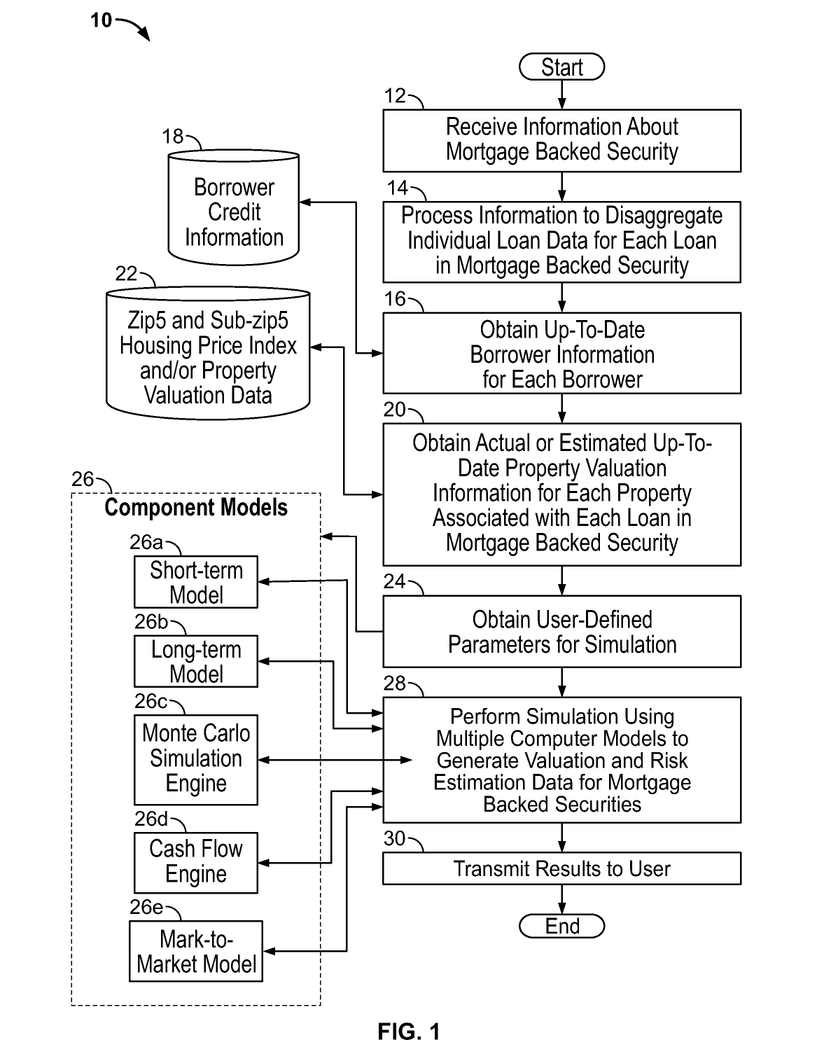

FIG. 1 is a flowchart of a process 10 according to the present disclosure for mortgage-backed security valuation and risk estimation. The process 10 could be executed by a specially-programmed computer system, which could be networked or web-based. Beginning in step 12, information about a mortgage-backed security is received by the computer system. In step 14, the information is processed to disaggregate individual loan data for each loan in the MBS. In step 16, the system obtains up-to-date borrower information for each loan, such as from one or more borrower credit information databases 18. In step 20, the system obtains actual or estimated up-to-date property valuation information for each property associated with each loan in the MBS. This information could be calculated or obtained from a database holding such information, such as a zip5 and sub-zip5 housing price index and/or property valuation database 22. In step 24, the system obtains user-defined parameters for simulation, which could be processed by component models 26 as discussed below, so as to model various aspects (components) of the MBS. Users can easily define desired assessments of key drivers such as interest rates and house price index (HPI). These assessments are then inputted into the system, which then generates probability distributions of cash flows and values of the MBS.

In step 28, the system performs a simulation of future MBS scenarios (e.g., predicted valuation and/or risk parameters associated with the MBS) using multiple component models 26 (or engines) to generate valuation and risk estimation data for an MBS. Such component models include a short-term model 26a, a long-term model 26b, Monte Carlo simulation engine 26c, cash flow engine 26d, and Mark-to-Market model 26e. The engines/models are based on granular loan/borrower-level data and multi-path multi-factor simulations that could generate model-based estimates and confidence intervals, or be calibrated to produce market-based valuations. Further, the models of the system use a behavioral approach to more accurately predict short-term CPR and/or CDR and use macro data for longer-horizon CPR/CDR vectors (as opposed to models that are primarily based on HPA and interest rates). These models/engines could be used sequentially or in parallel, and are described in more detail below.

In step 30, the results of simulation/modeling are transmitted to a user, e.g., by way of a graphical user interface that illustrates predicted future values of the MBS, as well as associated predicted risk parameters (e.g., probability of future default), as well as other parameters. The system provides an integrated user interface that allows users to “partner with the machine” to bring opportunities and risk to light. The user interface could include a variety of stratified reports that comprehensively explain all different facets of a portfolio of bonds and/or their underlying loans along various dimensions so that the user has direct and transparent access to different metrics of the portfolio.

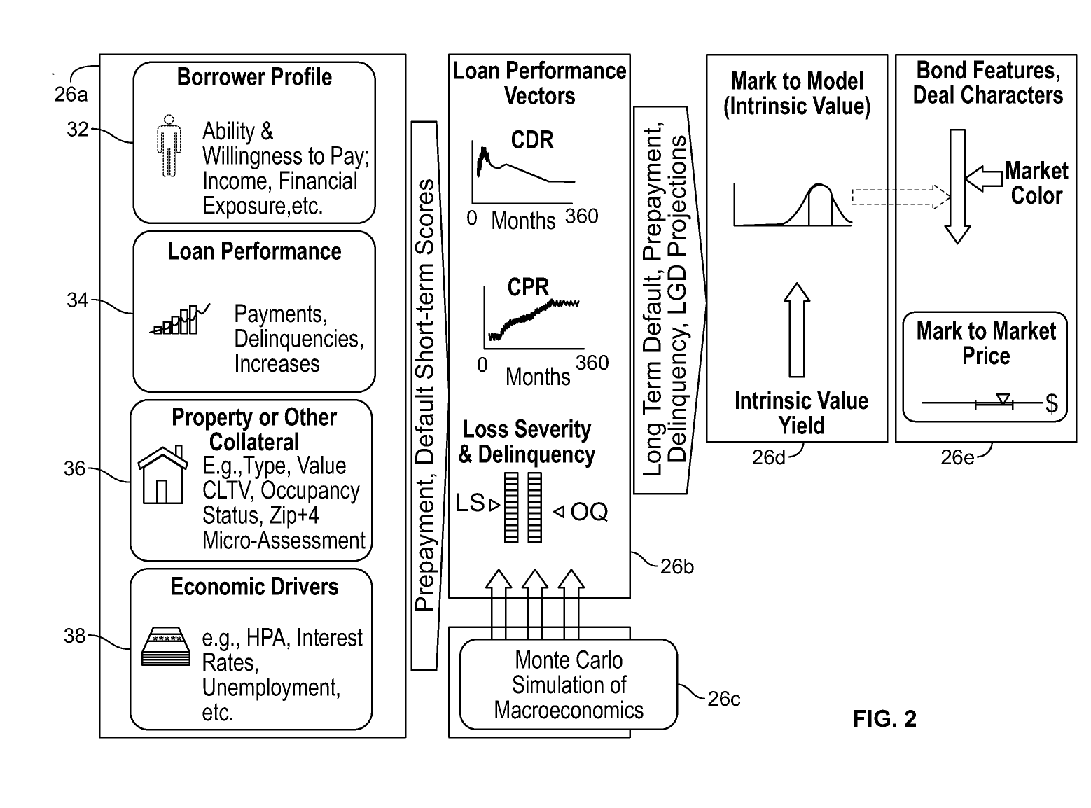

FIG. 2 is a diagram illustrating computer models 26a-26e of the system of the present disclosure for mortgage-backed security valuation and risk estimation. The models include short-term model 26a, a long-term model 26b, Monte Carlo simulation engine 26c, cash flow engine 26d, and Mark-to-Market model 26e. The short-term model 26a processes information about a borrower's immediate behavior and continuously updates to capture signals of changes in behavior and risk utilizing a variety of information such as a borrower profile 32 (e.g., credit bureau score, ability and willingness to pay, income, and financial exposure), loan performance 34 (e.g., payment history, delinquency status, and historical changes), property or other collateral 36 (e.g., type, value, combined loan-to-value (CLTV), occupancy status, and Zip+4 micro-assessment), and/or economic drivers 38 (e.g., housing price appreciation (HPA), interest rates, and unemployment). Loan origination and/or up-to-date information could be incorporated as model parameters. Different versions of the short-term models 26a could be built for different segments of the population of loans by segmenting loans by their performance history (e.g., loans that have been modified) and/or intrinsic characteristics, such as collateral type (e.g., Prime, Alt-A, Subprime), interest rate type (fixed, adjustable rate mortgage (ARM)), etc. The short-term model 26a could generate one or more default short-term scores and output any prepayment information (e.g., prepayment scores), which could be the input for the long-term model 26b.

The long-term model 26b produces long-term estimates of default, prepayment, loss severity, and delinquency at the individual loan level. Relevant information is gathered at the loan level and combined with highly granular home price indices along with projections of future macroeconomic factors obtained from the Monte Carlo simulation engine 26c (discussed below in more detail). Different versions of the long-term models 26b could be built for different segments of the population of loans by segmenting loans by their performance history (e.g., loans that have been modified) and/or intrinsic characteristics, such as collateral type (e.g., prime, Alt-A, subprime), interest rate type (fixed, ARM), etc.

The long-term model 26b focuses on marco-economic variables, periodically updates to capture low frequency signals, and analyzes scenarios based on multiple variables (e.g., HPA, unemployment, etc.) and their probability distribution. This can be achieved through various methods, such as by using a state transition matrix model. There could be a state transition matrix for each model for each population segment. The state transition matrix model could be a matrix whose product with the state vector at an initial time t gives state vector at a later time t=t+1 for each loan. The transition matrix could be a (n×n) matrix in which each element represents the probability of a loan being in a certain status in a current month, given the loan status of the previous month. Loan status information could include current status, prepayment status, days past due status (e.g., 60 days past due), and default status (e.g., foreclosure, bankruptcy, real estate owned (REO), liquidation, etc.). Probabilities in the matrix are generated by the following:

Pᵢⱼ=f(ME₁,ME₂, . . . IB₁,IB₂, . . . IL₁,IL₂, . . . G(Age)) Equation 4

where MEₙ is market effect variables, IBₙ is bureau information, and ILₙ is individual loan information. For example, month 1 could have status probabilities of 100% for current and 0% each for 60 days past due (DPD), default, and prepayment. Then using one or more transition matrices, the status probabilities of the loan at Month n could be estimated to be 65% for current, 15% for 60 DPD, 10% for default (e.g., CDRₙ), and 10% for prepayment.

The transition dynamics of the transition matrix could be modeled using multinomial logistic regression. Maximum likelihood estimation (MLE) parameter estimation could be used in multinomial logistic regression where the parameters could be:

$$\begin{matrix}Equations 5 and 6 & \\ {π}_{j} = p ( y = j \vert x , {β}_{1} , … , {β}_{r - 1} ) for j = 1 , … , r & ( 5 ) \\ {y}_{j} = \{ \begin{matrix}1 , & y = j \\ 0 , & otherwise\end{matrix} & ( 6 )\end{matrix}$$

The likelihood function could be represented as:

l(θ;x,y)=log Πⱼ₋₁^{r}πⱼ^{y}^{ⱼ}=Σⱼ₌₂^{r-1}yⱼ\vec{β}ⱼ^{T}\vec{J}ⱼ(x)−log(1+Σⱼ₌₁^{r-1}exp(\vec{β}ⱼ^{T}\vec{J}ⱼ(x))) Equation 7

Such a method uses different predicators for different classes. The first order derivative could be represented as:

$$\begin{matrix}Equation 8 & \\ \frac{\partial ( θ ; x , y )}{\partial {β}_{j , h}} = {y}_{j} {x}_{{J}_{k}} - \frac{exp ( {\vec{β}}_{j}^{T} {\vec{J}}_{j} ( x ) )}{1 + {\sum }_{k = 1}^{r - 1} exp ( {\vec{β}}_{k}^{T} {\vec{J}}_{k} ( x ) )} {x}_{{J}_{k}} & \end{matrix}$$

The second order derivative could be represented as:

$$\begin{matrix} Equation 9 & \\ \frac{{\partial }^{2} l ( θ ; x , y )}{\partial {β}_{k , h} , \partial {β}_{j , h}} = \frac{exp ( {\vec{β}}_{j}^{T} {\vec{J}}_{j} ( x ) ) exp ( {\vec{β}}_{k}^{T} {\vec{J}}_{k} ( x ) ) {x}_{{J}_{h}} , {x}_{{J}_{k}}}{{( 1 + {\sum }_{k = 1}^{r - 1} exp ( {\vec{β}}_{k}^{T} {\vec{J}}_{k} ( x ) ) )}^{2}} - {δ}_{kj } \frac{exp ( {\vec{β}}_{j}^{T} {\vec{J}}_{j} ( x ) ) {x}_{{J}_{h}} , {x}_{{J}_{k}}}{( 1 + {\sum }_{k = 1}^{r - 1} exp ( {\vec{β}}_{k}^{T} {\vec{J}}_{k} ( x ) ) )} & \end{matrix}$$

By the Newton-Raphson method, the iteration of

θ^{(t-1)}=θ^{(t)}+H⁻¹\vec{g} Equation 10

where H is the Hessian matrix and \vec{g} is the vector form of the first order derivative.

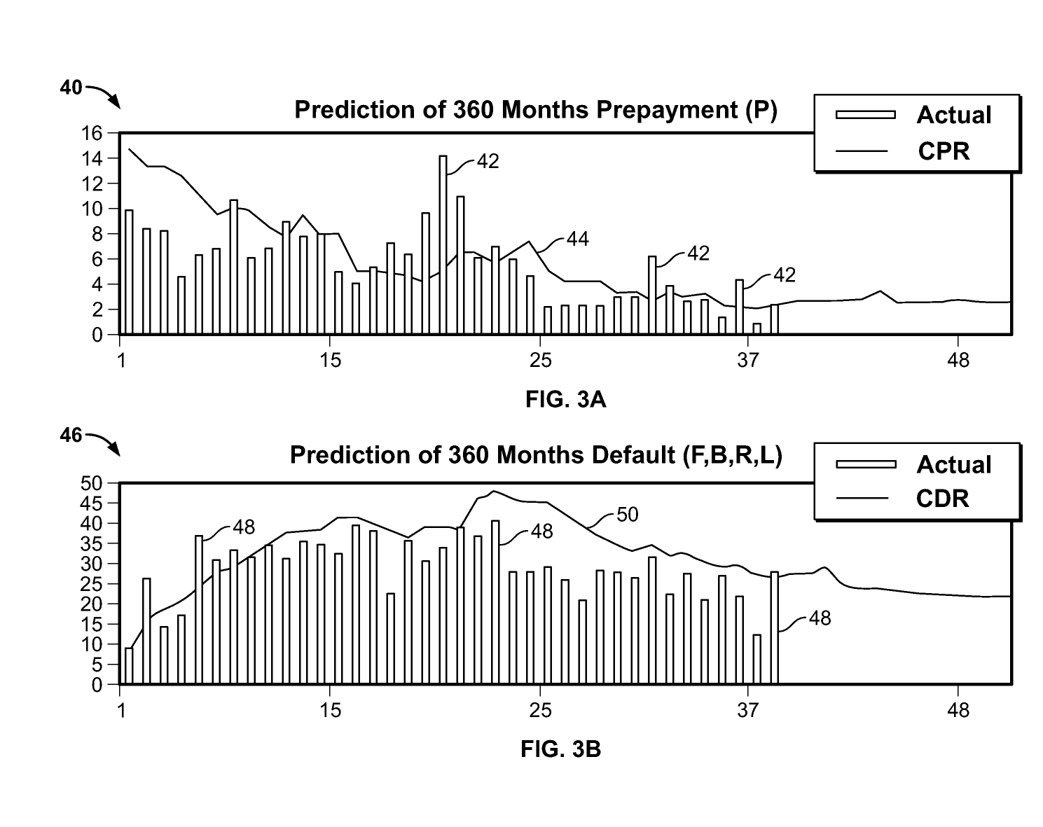

FIGS. 3A-3B are examples of the model performance of the transition matrix model. In these examples, the multinomial logistic regression model was used to predict the long-term (e.g., 30 years) default and prepayment probabilities. The model input was short-term model scores, macro-economy information, and loan and macro-economy combined variables (e.g., gap between loan interest rate and market interest rate). FIG. 3A is a graph 40 of the prediction of prepayment over 360 months, where the actual CPR 42 is represented as bars, and the predicted CPR is represented as a continuous line 44. FIG. 3B is a graph 46 of the prediction of default (including foreclosure, bankruptcy, REO, and liquidation) over 360 months, where the actual CDR 48 is represented as vertical bars, and the predicted CDR 50 is represented as a continuous line.

Referring back to FIG. 2, as part of the long-term model 26b, LGD is estimated over time based on a multi-factor loss severity model. The loss severity model could incorporate such factors as HPI, unemployment, interest rates, loan performance vectors (e.g., CDR and CPR), and delinquency, etc. The loss severity model could comprise a single statistical model, or a mixture of statistical models, that directly predicts the loss value, and an accounting model that predicts different components of the loss calculation.

The Monte Carlo simulation engine 26c works with the long-term model 26b, and simulates macroeconomic factors by building one or more individual models for HPI, unemployment rate, interest rates, and bond price distribution. These models incorporate both market expectations (e.g., forwards for interest rate) and user-specified views (e.g., future housing price and unemployment rate expectation). These models could generate multiple paths of various macroeconomic factors, the simulation engine could also account for historical correlation relationships among different assets.

The long-term model 26b and Monte Carlo simulation engine 26c output and generate information, such as long term default, prepayment, delinquency, and LGD projections, etc., which could then be fed into the cash flow engine 26d. The cash flow engine 26d incorporates the intrinsic value yield of a bond to calculate the intrinsic value of the bond. The cash flow engine could incorporate collateral positions in a deal, as well as waterfall structures, CDR, CPR, and loss severity. The results of the cash flow engine could then be inputted into the Mark-to-Market model 26e.

The Mark-to-Market model 26e captures/tracks relationship between features of a bond (e.g., deal characteristic, origination characteristics, cash flows, and capital structure position, etc.) and its price/effective yield (e.g., intrinsic value yield). To capture the relationship (e.g., correlations) between a bond's collateral and capital structure characteristics, and its market color and/or effective yield, the model 26e calculates a bond's “mark-to-market” value through a consortium of methods including clustering (e.g., bond clustering, hierarchical clustering), regression (e.g., linear regression, logistic regression), singular value decomposition (SVD), etc. The Mark-to-Market model 26e could utilize a linear regression model that predicts a financial security's (e.g., CUSIP) yield, so that its discounted cash flow matches the market color. The Mark-to-Market model 26e only needs to predict one variable, and provides the ability to capture some modeling bias in vector models. Also, vector models could be improved independently from the Mark-to-Market model 26e.

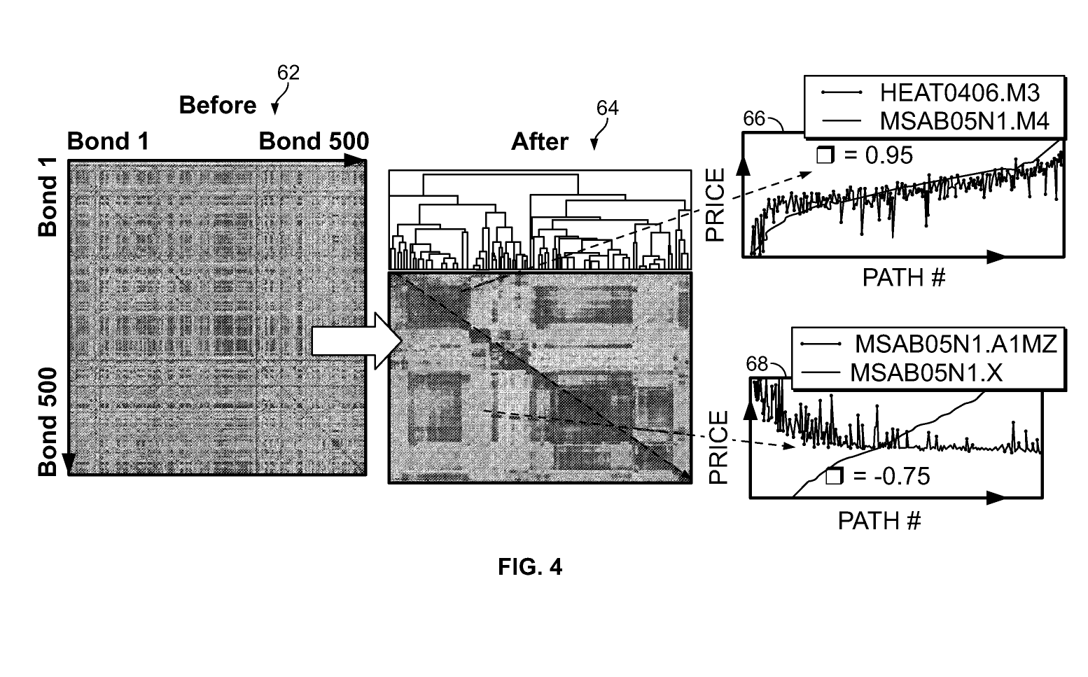

FIG. 4 is a visual illustration of bond clustering performed by the system using the Mark-to-Market model. Bond clustering creates clusters of similar bonds in order to uncover correlations, identify trading opportunities, and price bonds more accurately. Some approaches to clustering bonds include feature selection (e.g., cluster around deal characteristics, origination characteristics, cash flows, capital structure position, etc.), clustering criterion (e.g., fixed distance threshold, monotonic inconsistency, maximum number of clusters with monotonic inconsistency), and other clustering methods (e.g., hierarchical clustering). As shown, pre-clustered assets 62 are sequenced so that those ‘closer’ in behavior are clustered together as post-clustered assets 64. Graph 66 displays the resulting accuracy of the clustering method. Graph 66 shows two bonds whose prices co-vary among various macroeconomic paths. This graph 66 can be compared to graph 68 which displays two other bonds whose prices anti-correlate with macroeconomic change.

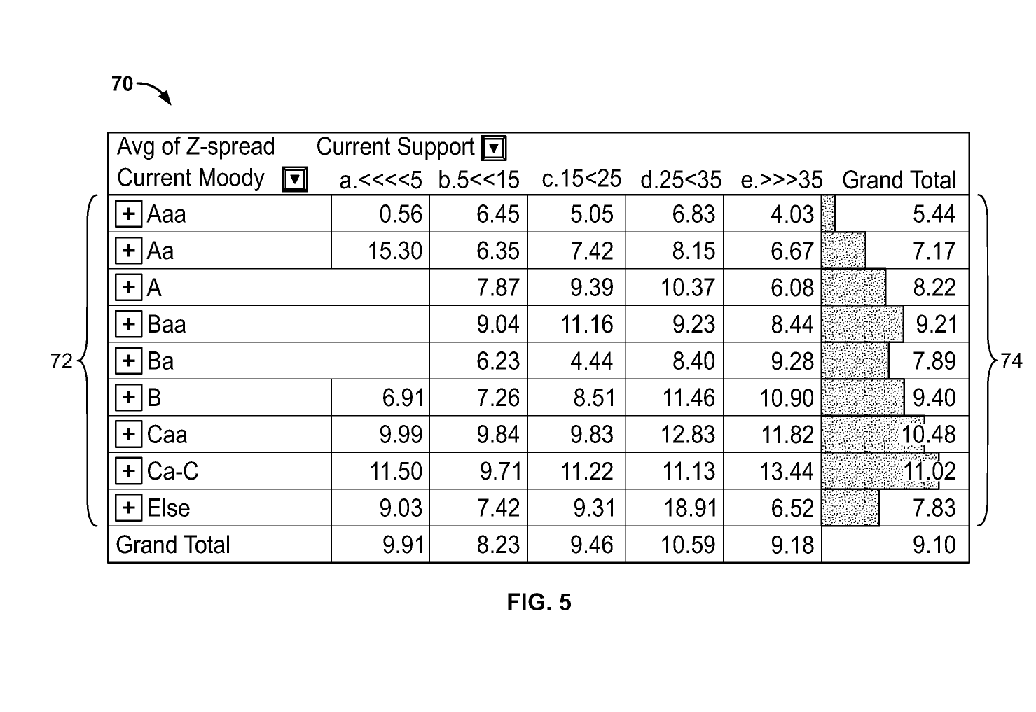

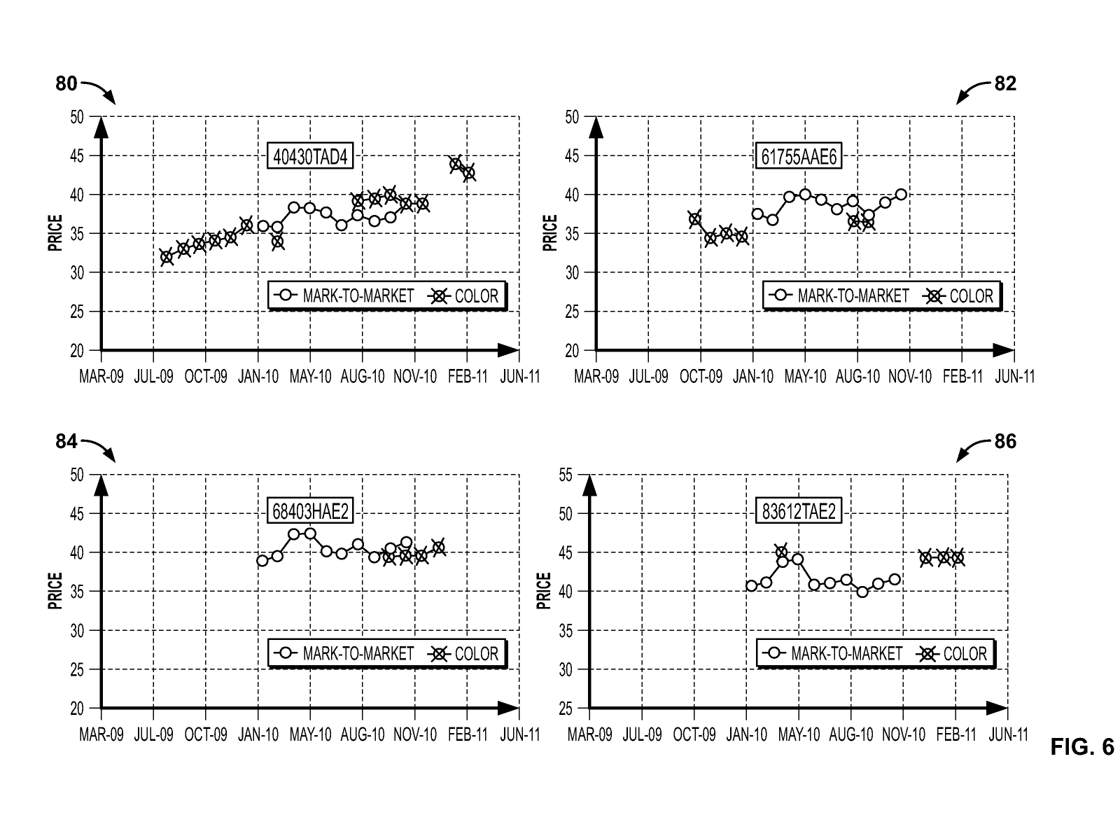

FIGS. 5-6 are figures illustrate operation of the Mark-to-Market model of the present disclosure. FIG. 5 is a table 70 illustrating automatic variables that could be used in the Mark-to-Market model. As shown, there is a strong relationship between Moody's ratings 72 and the target “mark-to-market” effective yield 74. FIG. 6 includes charts 80-86 showing a comparative analysis of actual market color compared to Mark-to-Market prices for asset-backed securities (ABX) index bonds.

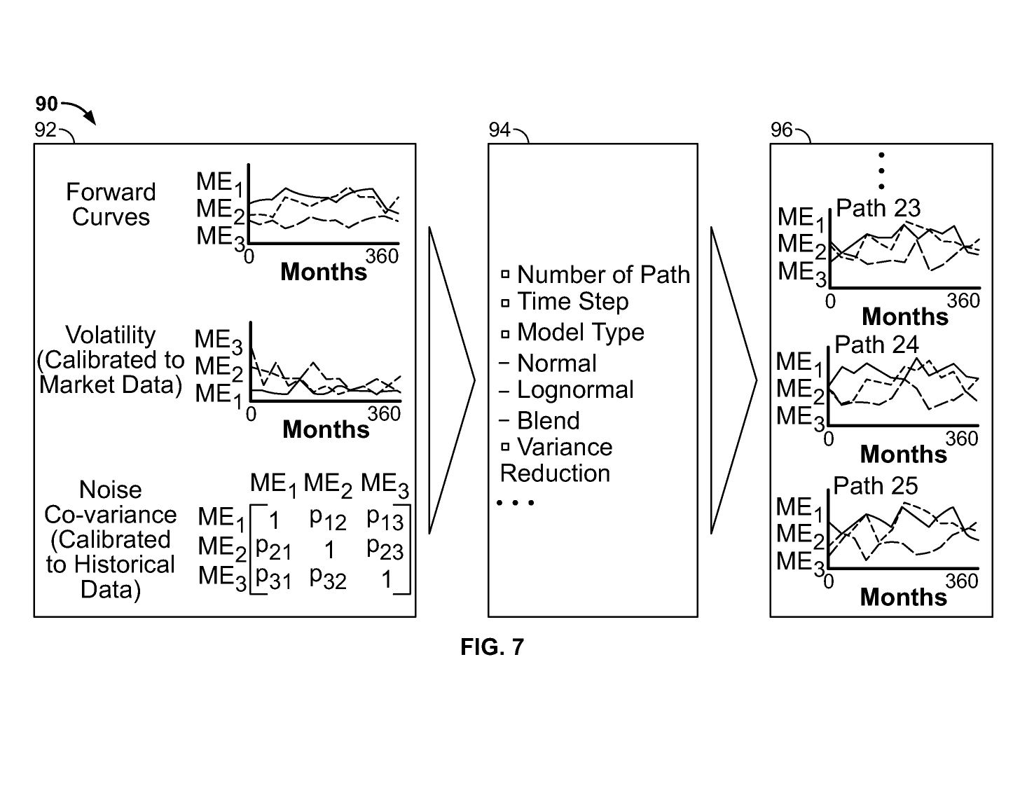

FIG. 7 is a diagram 90 showing the generation of market effect paths by the system using the Monte Carlo simulation engine of the system. The system could create hundreds of scenarios using Monte Carlo simulation to achieve accurate estimates of long-term value, rather than rely on a small number of “black-box” generated projections. Users could input their assessments of key drivers (e.g., interest rates, HPI, etc.) into the system, and then view the probability distributions of cash flows/values. As shown, information 92 relating to a desired scenario is first defined by the user, such as by using forward curves, volatility (calibrated to market data), and noise co-variance (calibrated to historical data). Then, settings 94 of the Monte Carlo model are customized 94, such as the number of paths, the time step, the model type (e.g., normal, lognormal, blend), variance reduction, etc. Then, the system generates a plurality of paths 96.

A lognormal model that could be used by the Monte-Carlo Simulation engine could be represented by:

$$\begin{matrix}Equation 11 & \\ F ( t + Δ t ) = F ( t ) \times {e}^{d ( t ) \times Δ t - \frac{{σ ( t )}^{2} \times Δ t}{2} + σ ( t ) \times W ( t )} & \end{matrix}$$

where F(t) is the current value at time t, Δt is the time step, d(t) is the drift at time t, σ(t) is the local volatility at time t. W(t) is a Winer process with a mean of 0, and a standard of \sqrt{ΔT}, and follows a correlation matrix on different assets. Then, d(t) could be explicitly computed from f(t), where f(t) is the forward curve that equals F(t) when σ(t) is 0 (the noiseless scenario).

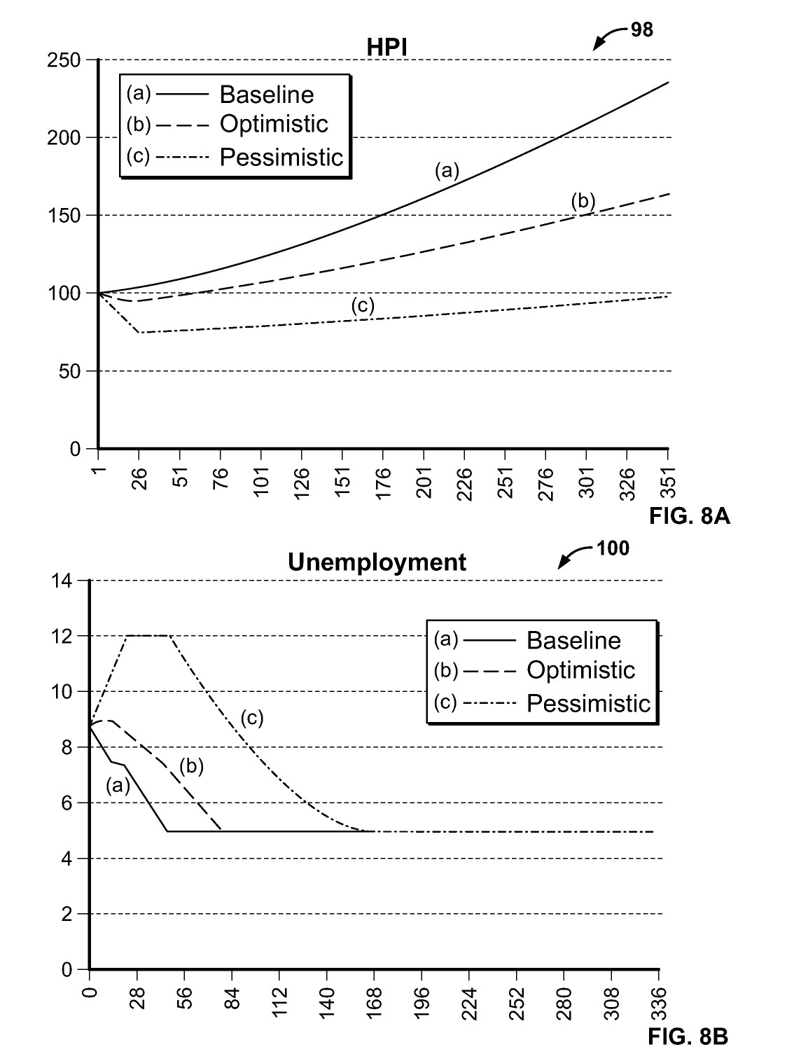

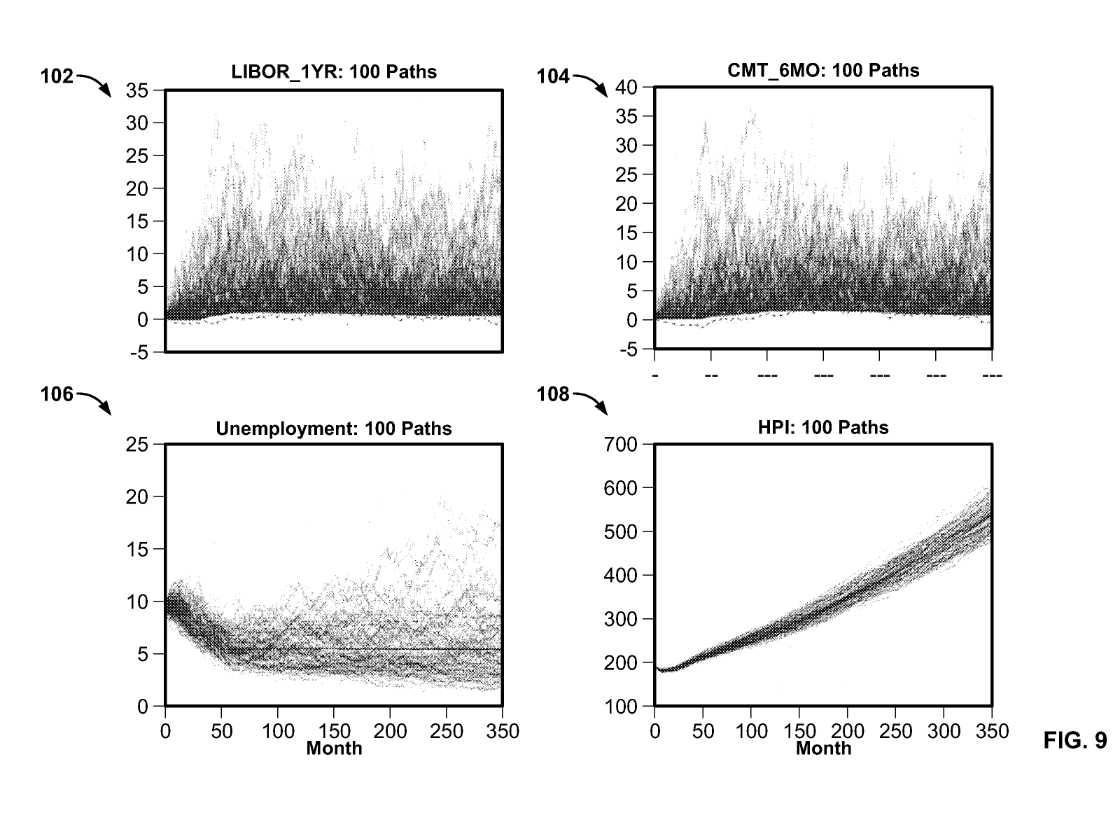

FIGS. 8A-9 are graphs illustrating the operation of the Monte Carlo simulation engine of the system. FIG. 8A illustrates an HPI lognormal model graph 98 and FIG. 8B illustrates an unemployment lognormal model graph 100. For each, the baseline, optimistic, and pessimistic projections are shown. The HPI lognormal model, interest rate (e.g., CIR++), and unemployment lognormal model could be linked by a set of correlation matrixes that define the random walk term. FIG. 9 are graphs showing various paths generated by the Monte Carlo simulation engine of the system. More specifically, shown is a Libor graph 102 over a 1 year period, a CMT (constant maturity treasury) graph 104 over a 6 month period, an unemployment graph 106, and an HPI path graph 108. Each of the graphs display 100 paths generated by the Monte Carlo simulation engine.

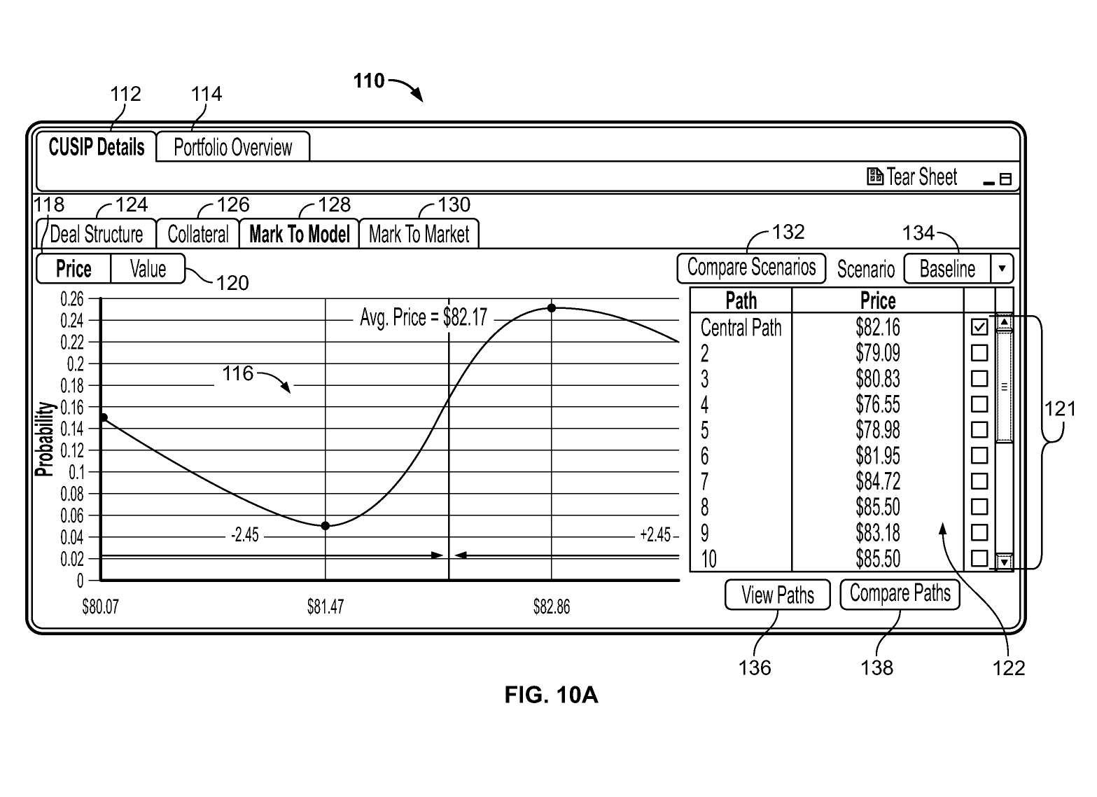

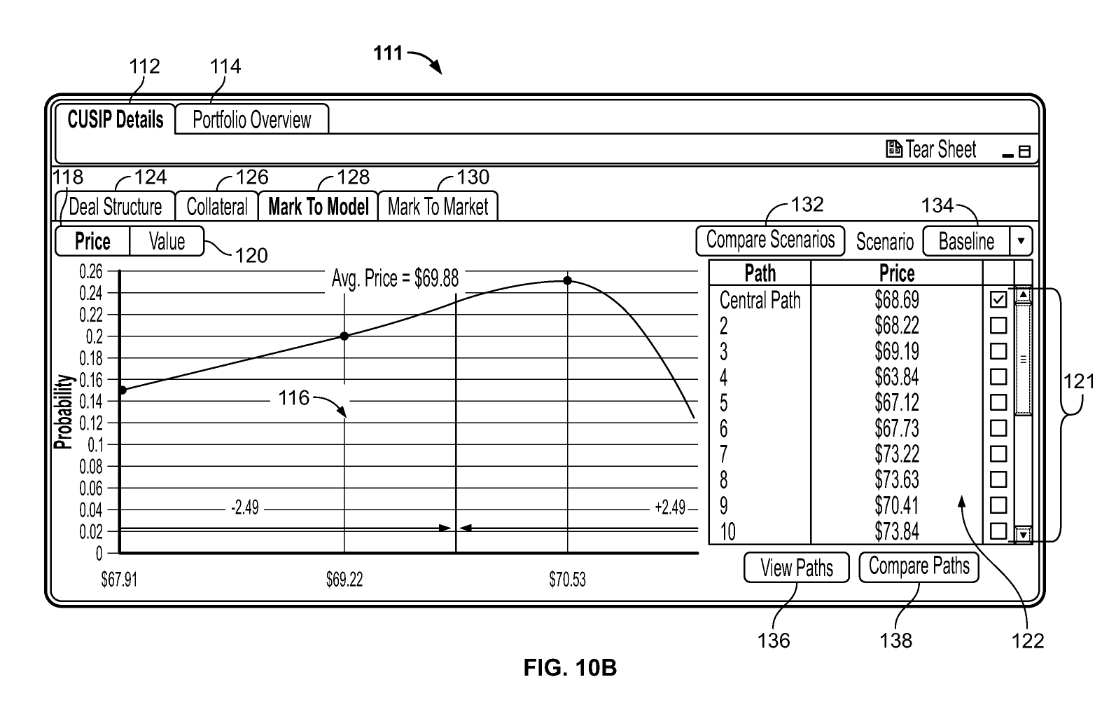

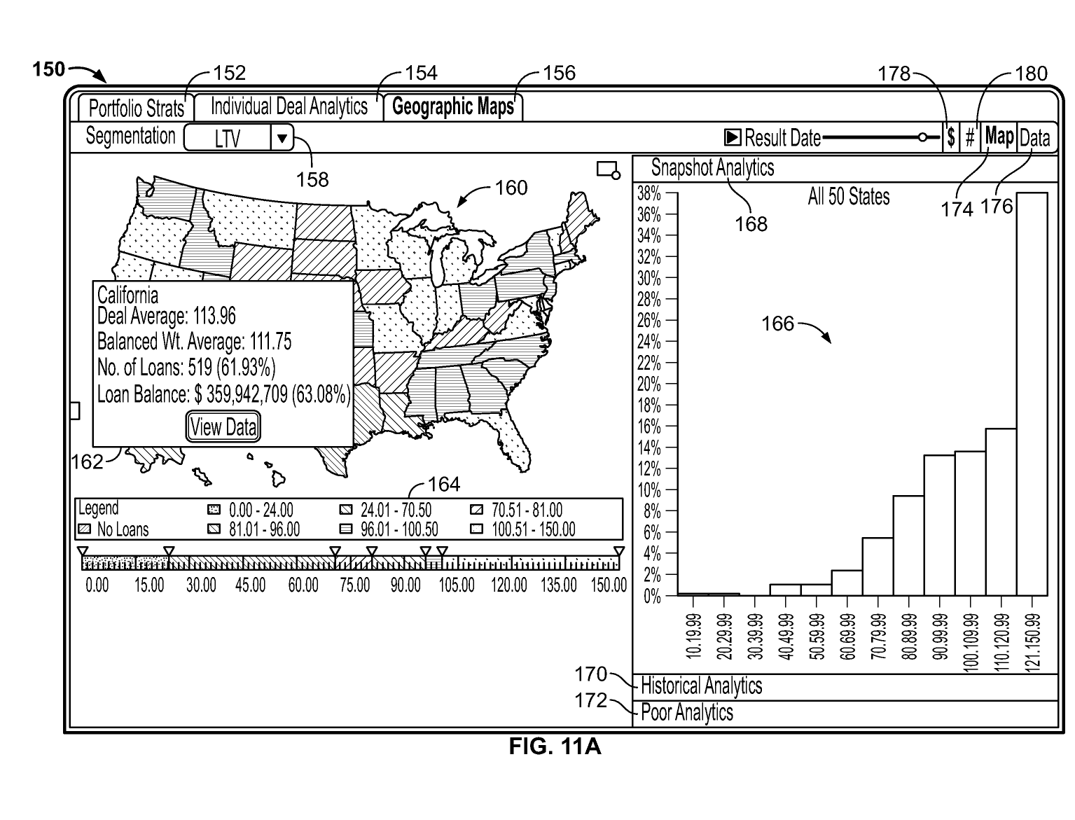

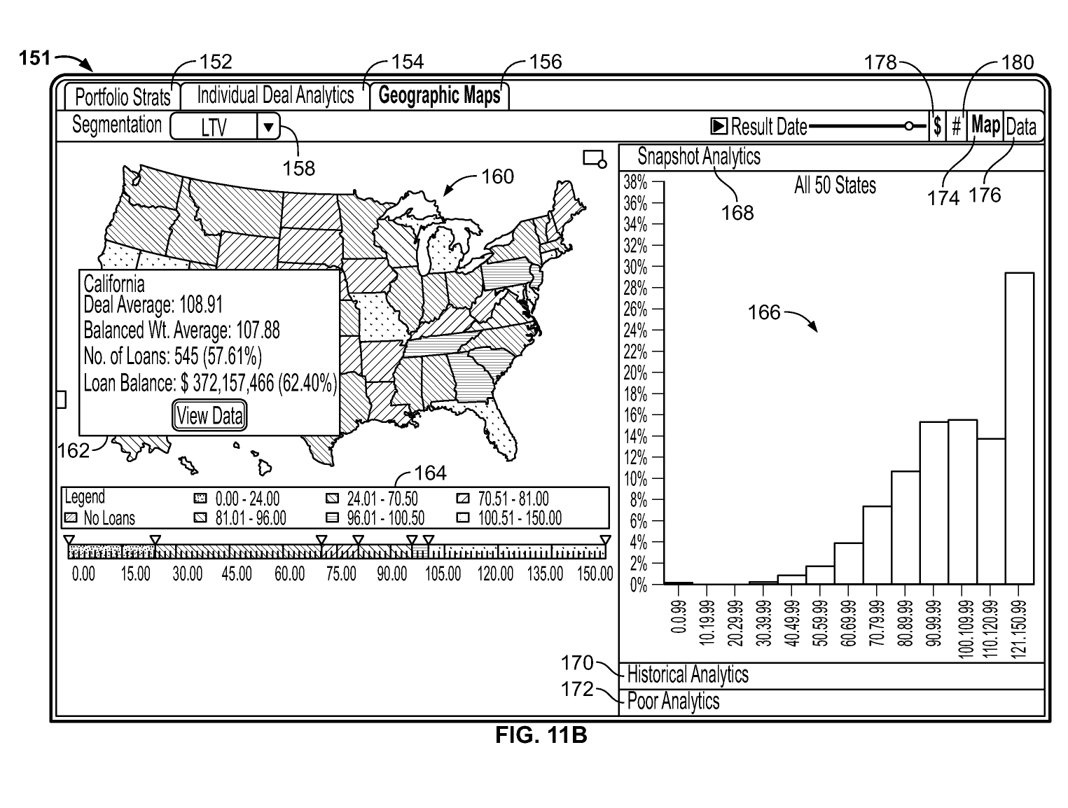

FIGS. 10A-11B are screenshots of user interface screens generated by the system of the present disclosure to output reports and information to a user. FIGS. 10A-10B show interfaces 110, 111 comprising a tabbed portion 112 allowing a user to view CUSIP details, and an overview tab 114 for viewing an overview of a current portfolio. Under the CUSIP details tab 112, the interface 110 comprises graph area 116, which could display probability as a function of price of a bond (although a user has the option via buttons to view the price 118 or value 120 of the bond). Chart area 122 could be used in conjunction with graph area 116 to display various data points of the graph. Checkboxes 121 could be used to toggle between the paths generated by the system, which allows the user to view one or more paths individually or simultaneously. Tabbed portion 129-130 provide the user with the ability to compare deal structures, collateral, mark to model, and mark to market values. Buttons 132-138 allow the user to compare scenarios, as well as choose various types of scenarios, view a particular path, and compare paths.

FIGS. 11A-11B show user interface screens 150, 151 used by the system of the present disclosure. The screen 150 of FIG. 11A is related to the screen 110 of FIG. 10A, and the screen 151 of FIG. 11B corresponds to the screen 111 of FIG. 10B. In this interface, tabs 152-156 are available to allow a user to view portfolio strats, individual deal analytics, and geographic maps. Under the geographic maps tab 156, the user could choose a particular segmentation to view using the segmentation drop-down menu 158. An interactive map area 160 could provide information 162 about loans in a particular state (e.g., deal average, balanced weight average, number of loans, loan balance, etc.). A legend 164 could be provided that corresponds with the information generated in the map area 160. A chart area 166 could also be provided that corresponds with the map area 160 that provides snapshot analytics 168, historical analytics 170, and peer analytics 172. A user could choose to display a map 174 or specific data 176 in the map area 160. Further, a user could choose between buttons 178, 180 to display the price of the bonds or the number of bonds in the chart area 166.

FIGS. 10A-11B are also an example of the system comparing the value of two bonds. The interactive interfaces compare two bonds that are both in senior positions within their respective capital structures, backed by Alt-A collateral described in similar terms, and valued similarly by the market. The first bond (of FIGS. 10A and 11A) is a 2004 vintage with better performing collateral but has less credit support remaining. The second bond (of FIGS. 10B and 11B) is a 2007 vintage and exhibits sizeable delinquencies. The price distributions revealed that both bonds have similar price variability when exposed to the same economic stresses, as evidenced by the standard deviations of 2.49 and 2.45, respectively. On an expected basis, the 2004 bond shows an average price of $82.17 and the 2007 bond a price of $69.88. By scrutinizing the Monte Carlo simulation results through a quick visualization of each cash flow vector, the user can easily contrast key inputs into the cash flow engine for each asset, including default and prepayment rates, loss severity, and delinquency paths. The collateral supporting both bonds was seasoned and stressed by home price declines, resulting in higher than original LTVs and consequently more delinquencies and defaults. The collateral for the 2007 bond experienced higher stress, since many of the loans were originated at the peak of the housing bubble and suffered the largest declines in value (most of which was in California). By contrast, the collateral for the 2004 bond benefitted from home price appreciation prior to the housing collapse, resulting in comparatively smaller declines. This confirmed that the collateral was less of a concern for the 2004 bond. Both bonds were available at similar spot prices (2004 bond at $77 and the 2007 bond at $76). Comparing these values to the model's intrinsic value estimates, the first bond appeared underpriced by $5 while the second bond appeared overpriced by $6. The system also could provide a fair value of each bond using a multifactor model that evaluates a variety of bond and market characteristics, and by considering recent bid, offer, and execution prices for similar assets. For these two bonds, the same relationship was seen between the fair value estimates and the spot prices. The intrinsic prices ranged from $76-82 for the 2004 bond, and $64-74 for the 2007 bond. Thus, the 2004 bond was the better bargain with only a small exposure to downside losses and significant opportunity for upside gains. Presumably, the 2004 bond was discounted by the market due to more sector-based sentiment, rather than bond specific characteristics.

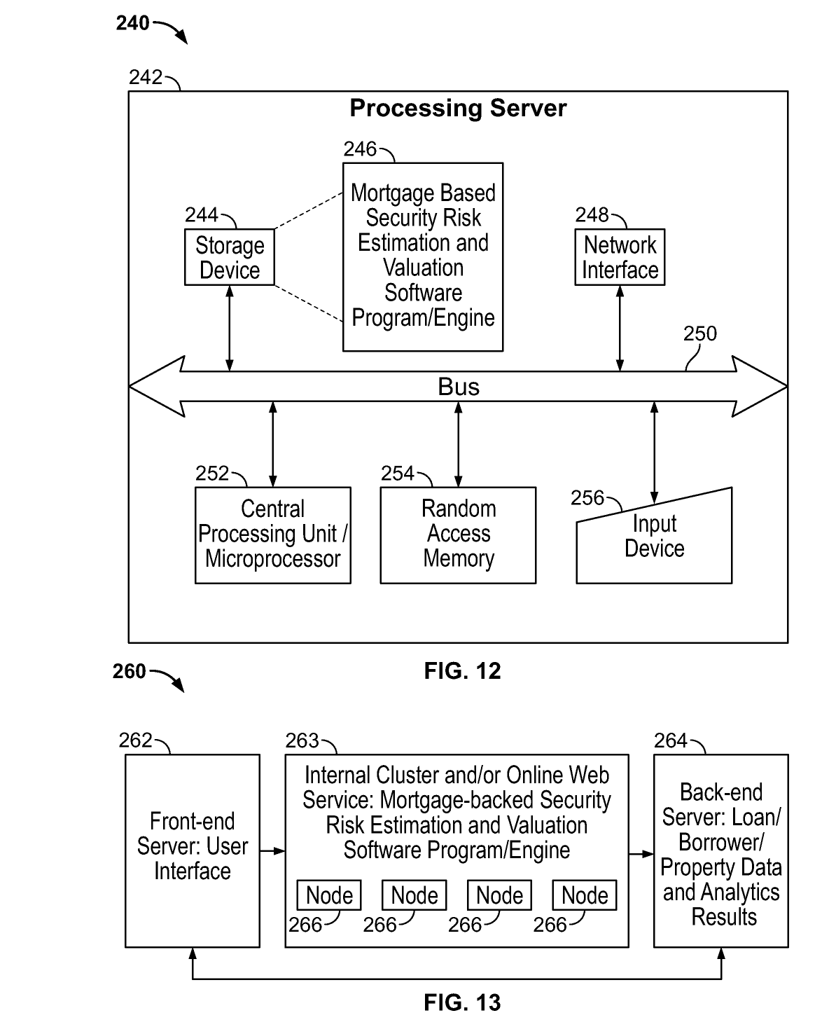

FIGS. 12-13 are diagrams showing hardware and software components of a computer system 200 capable of performing the processes discussed in FIGS. 1-11B above. FIG. 12 shows the computer system 240 comprises a processing server 242 which could include a storage device 244, a network interface 248, a communications bus 250, a central processing unit (CPU) (microprocessor) 252, a random access memory (RAM) 254, and one or more input devices 256, such as a keyboard, mouse, etc. The server 242 could also include a display. The storage device 244 could comprise any suitable, computer-readable storage medium such as disk, non-volatile memory (e.g., EPROM, EEPROM, a flash memory), etc. The functionality provided by the present disclosure could be provided by a mortgage based security risk estimation and valuation software program or engine 246, which could be embodied as computer-readable program code stored on the storage device 244 and executed by the CPU 252 using any suitable, high or low level computing language, such as Java, C, C++, C#, .NET, etc. The network interface 248 could include an Ethernet network interface device, a wireless network interface device, or any other suitable device which permits the server 242 to communicate via the network. The CPU 252 could include any suitable single or multiple-core microprocessor.

FIG. 13 shows another embodiment of the computer system 260 comprising a front-end server 262, internal cluster and/or online cloud-based storage and computation service 263 (e.g., Amazon S3, EC2, EMR, etc.), and a back-end server 264 for loan/borrower/property data and analytic results. The front-end server 262 could host a web-based user interface and support any data query via the interface. The internal cluster and/or online cloud-based storage and computation service 263 could comprise the mortgage-backed security risk estimation and valuation software program/engine and one or more computing nodes 266. The back-end server 264 could store all relevant data through a database or by any other suitable format.

Although the present disclosure has been described with reference to particular embodiments thereof, it is understood by one of ordinary skill in the art, upon a reading and understanding of the foregoing disclosure, that numerous variations and alterations to the disclosed embodiments will fall within the spirit and scope of the present disclosure and of the appended claims.

What is claimed is:

1. A system for investment product valuation and risk estimation, comprising:
a computer system for receiving information about a mortgage-backed security;
an engine executed by the computer system and processing the information about the mortgage-backed security to disaggregate individual loan data, the engine simulating future prices scenarios of the mortgage-backed security using one or more computer models to generate valuation and risk estimation data for the mortgage-backed security; and
a user interface generated by the system for presenting a report to a user which includes the future price scenarios of the mortgage-backed security.

2. The system of claim 1, wherein the one or more computer models comprise a short-term model for processing information about a borrower's immediate behavior and continuously updating the information to capture signals of changes in behavior and risk.

3. The system of claim 2, wherein the short-term model generates one or more short-term scores.

4. The system of claim 1, wherein the one or more computer models comprise a long-term model for producing long-term estimates of default, prepayment, loss severity, and delinquency at the individual loan level.

5. The system of claim 4, wherein the long-term model utilizes a state transition matrix model.

6. The system of claim 1, wherein the one or more computer models comprise a Monte Carlo simulation engine for generating one or more market effect paths.

7. The system of claim 6, wherein the Monte Carlo simulation engine builds individual models for HPI, unemployment rates, interest rates, and price distribution.

8. The system of claim 1, wherein the one or more computer models comprise a cash flow engine for calculating the intrinsic value of a mortgage-backed security.

9. The system of claim 1, wherein the one or more computer models comprise a Mark-to-Market model for calculating a mark-to-market value of a mortgage-backed security.

10. The system of claim 1, wherein the computer system is in electronic communication with one or more databases to receive up-to-date borrower information for the mortgage-backed security.

11. The system of claim 1, wherein the computer system is in electronic communication with one or more databases to receive up-to-date property valuation information for each property associated with the mortgage-backed security.

12. The system of claim 1, wherein the interface comprises interactive checkboxes to visually toggle between paths generated by the system.

13. The system of claim 1, wherein the engine clusters similar bonds of the mortgage-backed security.

14. A method for investment product valuation and risk estimation, comprising the steps of:
electronically receiving at a computer system information about a mortgage-backed security;
executing an engine to process the information about a mortgage-backed security using one or more models for simulation of future scenarios of the mortgage-backed security to generate valuation and risk estimation data for the mortgage-backed security; and
generating a user interface for presenting a report to a user which includes the future price scenarios of the mortgage-backed security.

15. The method of claim 14, wherein the one or more computer models comprise a short-term model for processing information about a borrower's immediate behavior and continuously updating the information to capture signals of changes in behavior and risk.

16. The method of claim 15, wherein the short-term model generates one or more short-term scores.

17. The method of claim 14, wherein the one or more computer models comprise a long-term model for producing long-term estimates of default, prepayment, loss severity, and delinquency at the individual loan level.

18. The method of claim 17, wherein the long-term model utilizes a state transition matrix model.

19. The method of claim 14, wherein the one or more computer models comprise a Monte Carlo simulation engine for generating one or more market effect paths.

20. The method of claim 19, wherein the Monte Carlo simulation engine builds individual models for HPI, unemployment rates, interest rates, and price distribution.

21. The method of claim 14, wherein the one or more computer models comprise a cash flow engine for calculating the intrinsic value of a mortgage-backed security.

22. The method of claim 14, wherein the one or more computer models comprise a Mark-to-Market model for calculating a mark-to-market value of a mortgage-backed security.

23. The method of claim 14, wherein the computer system is in electronic communication with one or more databases to receive up-to-date borrower information for the mortgage-backed security.

24. The method of claim 14, wherein the computer system is in electronic communication with one or more databases to receive up-to-date property valuation information for each property associated with the mortgage-backed security.

25. The method of claim 14, wherein the interface comprises interactive checkboxes to visually toggle between paths generated by the system.

26. The method of claim 14, wherein the engine clusters similar bonds of the mortgage-backed security.

27. A computer-readable medium having computer-readable instructions stored thereon which, when executed by a computer system, cause the computer system to perform the steps of:
electronically receiving at the computer system information about a mortgage-backed security;
executing an engine to process the information about a mortgage-backed security using one or more models for simulation of future scenarios of the mortgage-backed security to generate valuation and risk estimation data for the mortgage-backed security; and
generating a user interface for presenting a report to a user which includes the future price scenarios of the mortgage-backed security.

28. The computer-readable medium of claim 27, wherein the one or more computer models comprise a short-term model for processing information about a borrower's immediate behavior and continuously updating the information to capture signals of changes in behavior and risk.

29. The computer-readable medium of claim 28, wherein the short-term model generates one or more short-term scores.

30. The computer-readable medium of claim 27, wherein the one or more computer models comprise a long-term model for producing long-term estimates of default, prepayment, loss severity, and delinquency at the individual loan level.

31. The computer-readable medium of claim 30, wherein the long-term model utilizes a state transition matrix model.

32. The computer-readable medium of claim 27, wherein the one or more computer models comprise a Monte Carlo simulation engine for generating one or more market effect paths.

33. The computer-readable medium of claim 32, wherein the Monte Carlo simulation engine builds individual models for HPI, unemployment rates, interest rates, and price distribution.

34. The computer-readable medium of claim 27, wherein the one or more computer models comprise a cash flow engine for calculating the intrinsic value of a mortgage-backed security.

35. The computer-readable medium of claim 27, wherein the one or more computer models comprise a Mark-to-Market model for calculating a mark-to-market value of a mortgage-backed security.

36. The computer-readable medium of claim 27, wherein the computer system is in electronic communication with one or more databases to receive up-to-date borrower information for the mortgage-backed security.

37. The computer-readable medium of claim 27, wherein the computer system is in electronic communication with one or more databases to receive up-to-date property valuation information for each property associated with the mortgage-backed security.

38. The computer-readable medium of claim 27, wherein the interface comprises interactive checkboxes to visually toggle between paths generated by the system.

39. The computer-readable medium of claim 27, wherein the engine clusters similar bonds of the mortgage-backed security.
